(19) United States
(12) Patent Application Publication
(10) Pub. No.: US 2017/0198841 A1
(43) Pub. Date: Jul. 13, 2017

(54) Sealing Component for Pipe

(71) Applicant: Rongzhang Yi, Fushun (CN)

(72) Inventor: Rongzhang Yi, Fushun (CN)

(21) Appl. No.: 15/336,837

(22) Filed: Oct. 28, 2016

(30) Foreign Application Priority Data
Jan. 12, 2016 (CN) 201620027133.2

(51) Int. Cl. F16L 15/00

(52) U.S. Cl. CPC F16L 15/008

(57) ABSTRACT

The invention relates to a sealing component for pipe which includes the pipe and the connector for connecting the pipe and the thread. The external wall of the pipe's end has the external thread. The connector is in the shape of pipe and the internal wall of the connector has the internal thread. The wall of the pipe's end has the extension and the end of the extension's wall has the ring-form slope. Inside the connector, there has the baffle ring integrated with the connector. The ring-form shoulder joined the extension is closed to the ring wall of the baffle ring's central part. Inside the ring-form shoulder, there has the sealing ring which includes the elastic sealing ring or metal sealing ring.

### FIELD OF THE INVENTION

This invention relates to a sealing component for pipe.

### BACKGROUND OF THE INVENTION

The common method for present pipe connection is the threaded connection. The threaded connection's sealing surface is the occlusion between the thread or the limited sealing material which filled in the space between the thread. This method, however, can't meet the demand of different working condition. Besides, the bearing surface and the sealing surface are the same surface which can't bear the dynamic load. The sealing material will be damaged thus to lose the sealing efficacy if the surface bears the dynamic load. Basically, there is no sealing of the heavy loaded pipe connection like the drill pipe connection for drilling. Since the pressure leak and the medium loss is serious when the medium is input into the drill pipe, the efficiency is reduced greatly. These technologies are mastered by America, Germany and Japan but not us.

### SUMMARY OF THE INVENTION

Given the defects of present technology, this invention provides a sealing component for pipe which aims to separate the bearing surface and the sealing surface of the pipe threaded connection. And the bearing surface and the sealing surface work independently. In this way, the break of the bearing surface under the dynamic load and heavy load thus to make the sealing surface lose efficacy will be avoided.

To realize the purpose above, the following plan is applied: A sealing component for pipe which includes the pipe and the connector for connecting the pipe and the thread. The external wall of the pipe's end has the external thread. The connector is in the shape of pipe and the internal wall of the connector has the internal thread. The wall of the pipe's end has the extension. Inside the connector, there has the baffle ring integrated with the connector. The ring-form shoulder joined the extension is closed to the ring wall of the baffle ring's central part. Inside the ring-form shoulder, there has the sealing ring.

Further, the end of the extension's wall has the ring-form slope.

Further, the sealing ring includes the elastic sealing ring or metal sealing ring.

The beneficial effects of this invention: This invention separates the bearing surface and the sealing surface of the pipe threaded connection. And the bearing surface and the sealing surface work independently. In this way, the break of the bearing surface under the dynamic load and heavy load thus to make the sealing surface lose efficacy will be avoided. Meanwhile, a wedge-shape sealing cavity is formed between the ring-form slope and the ring-form shoulder. To enlarge the pressure of the sealing surface through the radial force in the sealing cavity and the radial force is formed by the internal surface of the sealing material. Thus to realize the self-compensation of sealing. This invention will reduce the frequency of replacement, increase the work efficiency and cut loss.

### BRIEF DESCRIPTION OF THE DRAWINGS

FIG. 1 is the structural drawing of this invention; and

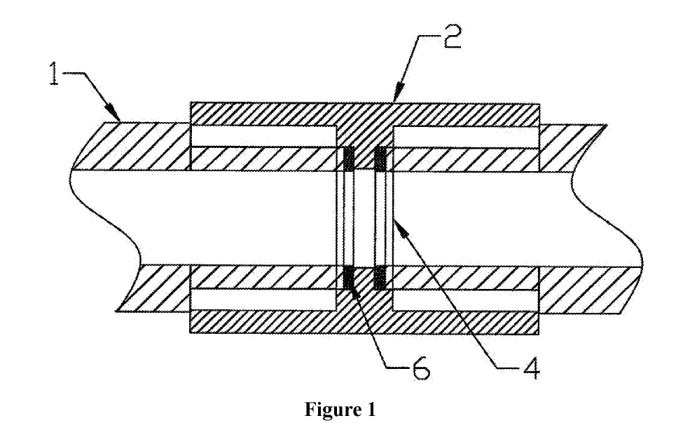

FIG. 2 is the local structural drawing of this invention.

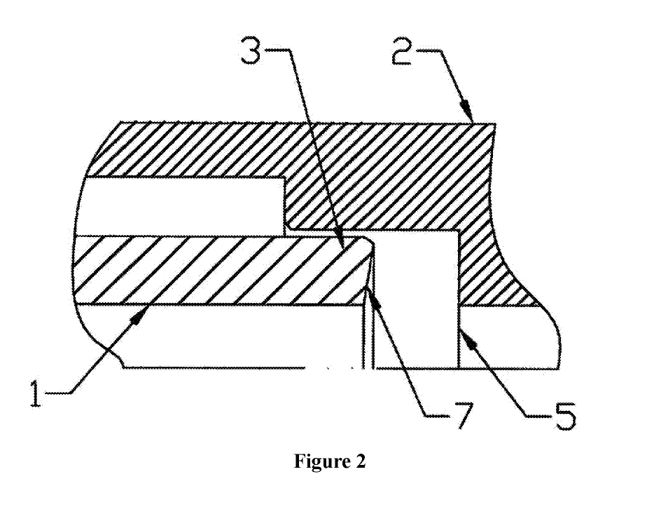

### DETAILED DESCRIPTION

In the following detailed description, reference is made to the accompanying drawings that form a part hereof, and in which it is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

A sealing component for pipe as shown in the drawing, which includes the pipe 1 and the connector 2 for connecting the pipe 1 and the thread. The external wall of the pipe's 1 end has the external thread. The connector 2 is in the shape of pipe and the internal wall of the connector has the internal thread. The wall of the pipe's end has the extension 3. Inside the connector 2, there has the baffle ring 4 integrated with the connector 2. The ring-form 5 shoulder joined the extension 3 is closed to the ring wall of the baffle ring's 4 central part. Inside the ring-form shoulder 5, there has the sealing ring 6. The end of the extension's 3 wall has the ring-form slope 7. The sealing ring 6 includes the elastic sealing ring or metal sealing ring.

In the embodiment, the sealing ring 6 is preset within the ring-form shoulder 5 thus to realize the threaded connection between pipe 1 and connector 2. In the process of screwing the pipe 1, the sealing ring 6 is squeezed against the baffle ring 4 by the extension 3. Then the assembling is accomplished. Under the heavy load, the threaded connection created by the internal and external thread will be the bearing surface. The sealing structure created by the sealing ring and the ring-form shoulder 5 will be the sealing surface. The bearing surface and the sealing surface will act independently. In this way, the break of the bearing surface under the dynamic load and heavy load thus to make the sealing surface lose efficacy will be avoided. Meanwhile, a wedge-shape sealing cavity is formed between the ring-form slope 7 and the ring-form shoulder 5. To enlarge the pressure of the sealing surface through the radial force in the sealing cavity and the radial force is formed by the internal surface of the sealing material. Thus to realize the self-compensation of sealing. This invention will reduce the frequency of replacement, increase the work efficiency and cut loss.

The above embodiments only describe one or several embodiments of the invention, its description is more concreted and detailed but cannot hence be understood to limit the scope of the patent of the invention. It should be pointed out that those skilled in the art can also make a plurality of modifications and improvements without departing from the concept of the invention, which all belong to the protection scope of the invention. Therefore, for the protection scope of the patent of the invention, the appended claims should prevail.

1. A sealing component for pipe which includes the pipe(1)and the connector(2) for connecting the pipe(1) and the thread. The external wall of the pipe's(1) end has the external thread. The connector(2) is in the shape of pipe and the internal wall of the connector has the internal thread. The wall of the pipe's end has the extension (3). Inside the connector(2), there has the baffle ring(4) integrated with the connector(2). The ring-form shoulder(5) joined the extension(3) is closed to the ring wall of the baffle ring's(4) central part. Inside the ring-form shoulder, there has the sealing ring.

2. A sealing component for pipe according to claim 1, wherein the end of the extension's (3)wall has the ring-form slope(7).

3. A sealing component for pipe according to claim 1, wherein the sealing ring which includes the elastic sealing ring or metal sealing ring.
